(19) United States
(12) Patent Application Publication
(10) Pub. No.: US 2009/0316393 A1
(43) Pub. Date: Dec. 24, 2009

(54) COMPOSITE LIGHT SOURCE

(75) Inventors: Michel Cornelis Josephus Marie Vissenberg, Eindhoven (NL); Ramon Pascal Van Gorkom, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N V, Eindhoven (NL)

(21) Appl. No.: 12/373,525

(22) PCT Filed: Jul. 5, 2007
(86) PCT No.: PCT/IB07/52632

§ 371 Date: Jan. 13, 2009

(30) Foreign Application Priority Data
Jul. 18, 2006 (EP) 06117403.3

(51) Int. Cl. F21S 2/00

(52) U.S. Cl. 362/231

(57) ABSTRACT

This invention relates to a composite light source (101) for generating light of a predetermined colour. The light source has a plurality of sub-modules (102-104), which are each able to generate light of that predetermined colour Each sub-module has a light collimating and mixing structure (102-104) and a light unit group (105-107) consisting of a plurality of coloured light units (109a-109c), which are arranged at an entrance (102a-104a) of the collimating and mixing structure. In order to obtain a homogenizing interaction of the light emitted from the light unit groups, looking at a given light unit position in different light unit groups, light units of different colors are mounted in that position.

### FIELD OF THE INVENTION

The present invention relates to a composite light source comprising a plurality of sub-modules, wherein each sub-module comprises a light collimating and mixing structure and a light unit group, arranged at an entrance of the collimating and mixing structure.

### BACKGROUND OF THE INVENTION

By the term composite light source is meant a light source which contains a plurality of individual light units that cooperate to form the light source. A typical type of composite light source is a solid state light source, in particular a LED (Light Emitting Diode) light source, although other types exist as well. The development of controllable high luminance LEDs of different colors has enabled the use of LEDs for making light sources with active beam control, such as colour control, beam shape and directional control.

In order to make a colour variable light source several LED units of different colours have been combined at the entrance of a light collimating and mixing system, that is aimed at producing a light beam of uniform colour. Such a LED light source is described in WO 00/58664, where a large number of LEDs are arranged at the entrance of a collimating and mixing structure. Typically, but not at all necessarily, a white RGB LED light source is arranged, i.e. white light generated by means of a combination of red, green and blue LEDs. The more LEDs that are co-arranged at the entrance, the better colour homogeneity of a light spot, in the far field, generated by the light source.

Unfortunately, the more LEDs, the wider and longer the collimating and mixing structure becomes.

### SUMMARY OF THE INVENTION

It is an object of the present invention to provide a composite light source that alleviates the above-mentioned drawbacks of the prior art light sources.

This object is achieved by a composite light source according to the present invention as defined in claim 1.

Thus, in accordance with an aspect of the present invention, there is provided a composite light source for generating light of a predetermined colour, comprising a plurality of sub-modules, each comprising means for generating light of said predetermined colour, said means comprising a light collimating and mixing structure and a light unit group consisting of a plurality of coloured light units, which are arranged at an entrance of the collimating and mixing structure. The sub-modules are arranged with a predetermined mutual relationship of their respective light unit groups for obtaining a homogenizing interaction of the light emitted from the light unit groups. An implementation of the relationship comprises that, at a given light unit position in at least some of the light unit groups, there are provided differently coloured light units.

By, thus, taking the interaction of the emitted light from the sub-modules into account a more colour homogenized light spot generated by the composite light source is obtained, compared to that of prior art composite light sources where the interaction has not been considered in the same way. These interaction considerations are expressed by arranging the sub-modules with the predetermined mutual relationship of their light unit groups. In the structure of the composite light source this relationship is implemented in such a way that all the light unit groups are not identical as regards the light units. If one compares the colour of light emitted from a light unit at a particular position in one light unit group, or in the sub-module, with the colour of the light emitted from another light unit at the same position of another light unit group, the colours are different. This applies to some or all of the light unit groups of the light source and has a homogenizing effect.

Additionally, comparatively fewer light units can be arranged at the entrance of each collimating and mixing structure than in the prior art light source, yet obtaining a more colour homogeneous light spot. This advantageously enables the use of shorter collimating and mixing structures. The structure will also be more compact.

For the purposes of this application it should be noted that a coloured light unit typically consists of a single light emitting element, such as a LED die, but it could also consist of several light emitting elements, such as several LED dies, which emit the same colour and are arranged in such a way that they are considered to be one light unit. Additionally, said predetermined colour is typically white, but can be any desired colour.

In accordance with an embodiment of the composite light source as defined in claim 2, the mutual relationship is positional, and more particular a permutation of light unit positions, i.e. the positions of the light units of one light unit group are shifted relative to the positions of the light units of another light unit group. This is a well controllable way of obtaining the differently coloured light units at a given position.

In accordance with an embodiment of the composite light source as defined in claim 3, a good colour homogeneity is ensured by providing a light source in which the light units of each colour are placed in all possible positions throughout the sub-modules. For example, as defined in claim 4, the permutation can be a rotation.

In accordance with an embodiment of the composite light source as defined in claim 5, the mutual relationship is implemented by means of differently coloured light units in different light unit groups. In other words, the colour combination of the light units of one sub-module differs from the colour combination of the light units of another sub-module. There are additional examples of how to obtain the colour differentiation in a given position, and some of them will be described in the following.

In accordance with embodiments of the LED light source as defined in claims 7 and 8 advantageous numbers of sub-modules related to the number of light units in each sub-module are provided.

These and other aspects, features, and advantages of the invention will be apparent from and elucidated with reference to the embodiments described hereinafter.

### BRIEF DESCRIPTION OF THE DRAWINGS

The invention will now be described in more detail and with reference to the appended drawings, in which:

FIGS. 1 and 2 are schematic top views showing coloured light unit configurations of a composite light source according to different embodiments of the composite light source of the present invention;

FIG. 3 is a schematic cross-sectional view of an embodiment of the composite light source according to this invention; and

FIG. 4-6 show coloured light unit configurations of a composite light source according to further embodiments of the composite light source of the present invention.

### DESCRIPTION OF PREFERRED EMBODIMENTS

When designing a composite light source based on differently coloured light units the resulting light spot ideally is totally homogeneous, or unicolored, as regards the colour thereof. For example, a white light source is desired to generate a light spot that in every part has the same shade of white. This is not the case when light units of different colours, such as for example red, green and blue (RGB), are mixed to form the white light. Traditionally, more or less complex mixing systems comprising a collimator, a mixer unit, etc., have been arranged in front of the light units to enhance the mixing of the colours. Alternatively, or additionally, the number of light units within a collimator has been increased, by using several light units of each colour, and efforts have been made to place the light units intelligently within the collimator.

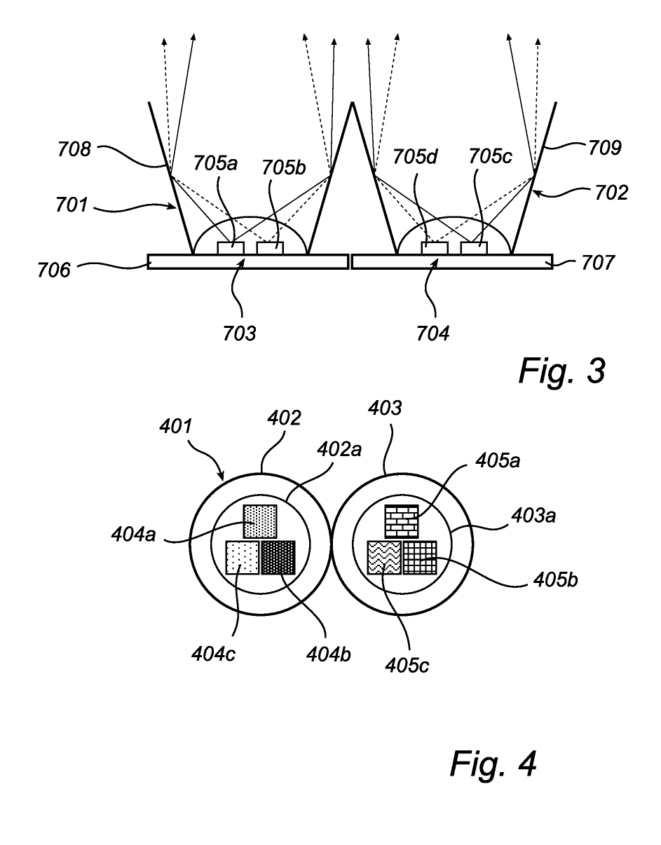

However, according to the present invention a further improvement has been achieved in a radically different way. Rather than trying to house an increasing number of light units within one and the same collimator, several collimators, each housing only a few light units, are combined to a larger unit. Each assembly of light units, collimating and mixing units, etc., is considered a sub-module. When performing the combination the interaction of the sub-modules, i.e. the superposition of light beams from the different sub-modules, has been taken into account in a constructive way. Thus, by configuring the light units not equally but unequally from one sub-module to a neighbouring sub-module, a positive interference, resulting in a homogenizing of the colour of the total light emitted from the different sub-modules. This can be explained by a simple schematic example where there are two sub-modules, as shown in FIG. 3. It should be noted, that for purposes of simplifying the description as well as giving a typical example, below it is assumed that each light unit is a LED. However, as mentioned above other types of light units are applicable as well.

Each sub-module 701, 702 comprises a LED group 703, 704 consisting of two LEDs 705a-b, 705c-d provided on a substrate 706, 707, and a light collimating and mixing structure 708, 709, which below simply will be called collimator. It should be noted that the shape of the collimator is most schematically illustrated. In practise the shape is typically more complex. The LEDs 705a-b, 705c-d are arranged at the entrance of the collimator 708, 709. The LEDs 705a-b, 705c-d of each sub-module 701, 702 emit differently coloured light. Thus, in the left sub-module 701 a LED 705a of a first colour is placed to the left of a LED 705b of a second colour, while in the right sub-module 702 the LED 705c of the first colour is placed to the right of the Led 705d of the second colour. For example, if the light source is to generate white light the first and second colours could be respectively red and cyan or blue and yellow.

In order to explain the light interaction between the sub-modules some light rays have been drawn, where the light rays of the first colour are represented by solid lines, while the rays ofthe second colour are represented by dashed lines. As can be seen in FIG. 3 the directional light distribution of the LED 705a of the first colour in the left sub-module 701 corresponds with the directional light distribution of the LED 705d of the second colour of the right sub-module 702. Consequently, by shifting the positions ofthe LEDs 705c-d of the right sub-module 702 in relation to the positions of the LEDs 705a-b of the left sub-module 701 a homogenizing interaction of the light emitted from the LED groups 703, 704 has been obtained.

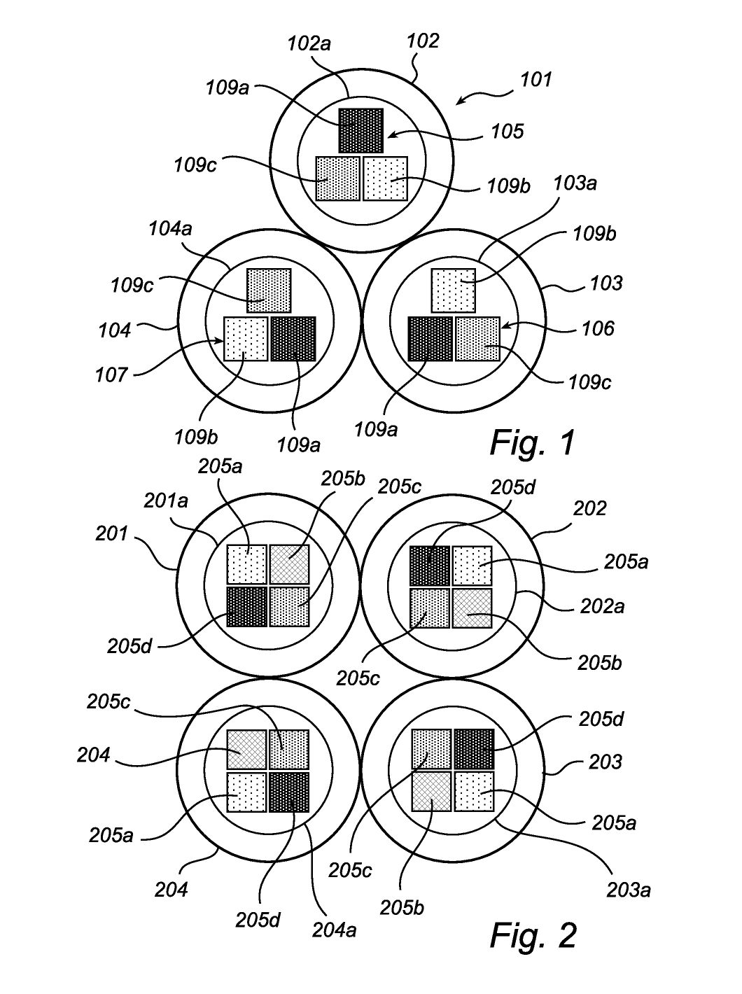

According to a first embodiment of the LED light source, as shown in FIG. 1, the LED light source 101 comprises three sub-modules 102, 103, 104, each housing one LED group 105, 106, 107 of three LEDs 109a, 109b, 109c. Numerals 102-104 also denote the maximum width of the collimators of the sub-modules, which typically and in the figures correspond to the exits of the collimators, while numerals 102a-104a denote the entrance, and also the minimum width, of the collimators. The sub-modules 102-104 are all neighbours of each other, and they are arranged in a triangle. Each LED group 105-107 consists of RGB LEDs, i.e. the LEDs 109a-c of each LED group 105-107 emit red, green, and blue light, respectively. It should be noted that in this figure, as well as in the other figures illustrating LEDs in a top view, the different colours are shown as different shadings of the squares that represent the LEDs. The LEDs of each LED group 105-107 are also arranged in a triangle. In this embodiment there are predetermined positional relationships between the LEDs 109a-c of the different sub-modules 102-104. Thus, in the top sub-module 102, for example, the top LED 109a is blue, the bottom right LED 109b is red, and the bottom left LED 109c is green. In the bottom right sub-module 103 the LEDs 109a-c have been rotated counter clockwise one step compared to the LEDs 109a-c of the top sub-module 102. Thus, the top LED 109b is red, the bottom right LED 109c is green, and the bottom left LED 109a is blue. In the bottom left sub-module 104 the LEDs 109a-c have been rotated counter clockwise compared to the LEDs 109a-c of the bottom right sub-module 103, and clockwise one step compared to the LEDs 109a-c of the top sub-module 102. That is, the top LED 109c is green, the bottom right LED 109a is blue, and the bottom left LED 109b is red.

Due to this way of arranging the sub-modules 102-104 with different permutations in the position of the coloured LEDs, the light spot generated by the light source 101 becomes substantially more homogeneous than the light spot of a light source having a single collimator or a plurality of collimators with the same configuration of the LEDs.

In another embodiment of the composite light source according to this invention, as shown in FIG. 2, there are four different LED colours, namely red, amber, green, and blue. There are four sub-modules 201, 202, 203, 204, thus housing one LED group of four LEDs 205a-d each, arranged at the entrance 201a-204a of the respective collimators. Moving clockwise from sub-module to sub-module the configuration of the LEDs, in terms of position, is rotated clockwise one step at a time.

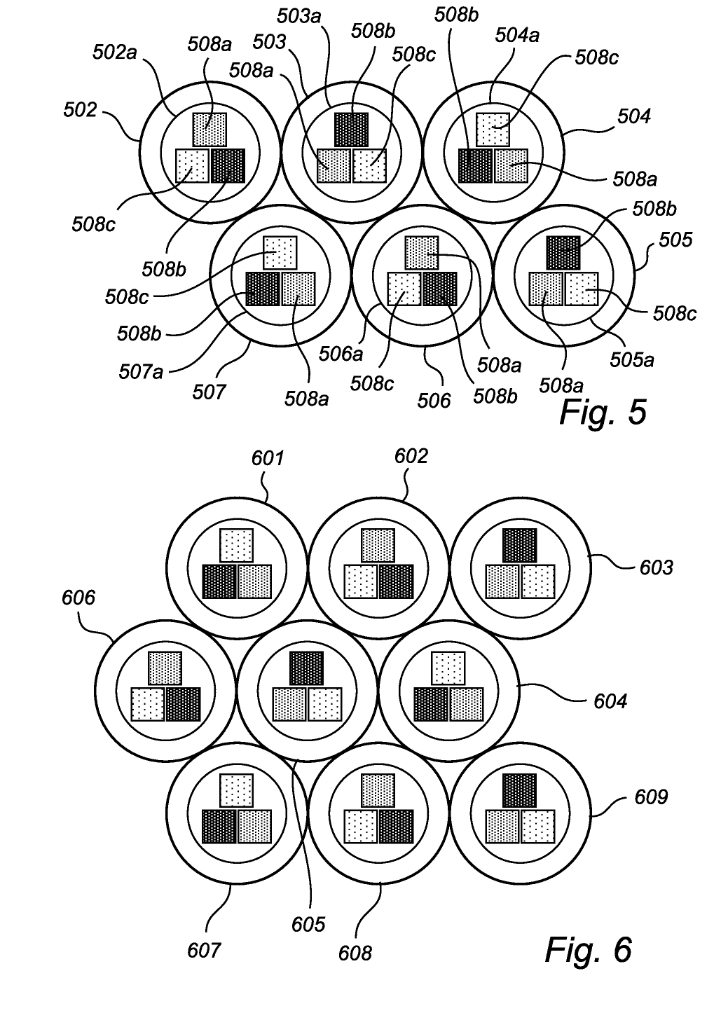

In addition to, or instead of, using sub-modules with the same colour combination of the light units it is possible to use sub-modules with differently coloured light units. This is exemplified in FIG. 4, where a first sub-module 402 and a second sub-module 403 having light units 404a-404c, 405a-405c arranged at respective entrances 402a, 403a of their collimating and mixing structures 402, 403 are shown. The first sub-module 402 comprises a green light unit 404a at the top, a blue light unit 404b at the bottom right, and a red light unit 404c at the bottom left, while the second sub-module 403 comprises a magenta light unit 405a at the top, a yellow light unit 405b at the bottom right, and a cyan light unit 405c at the bottom left. The green, blue and red light add up to white, and so does the magenta, yellow and cyan light. Further, the light units at a specific position of the first and second sub-modules 402, 403 also add up to white. That is, green and magenta, blue and yellow, and red and cyan respectively add up to white light. Thus, in this embodiment as well as in the other embodiment described here, all light units at a given position in the light unit groups add up to the same colour as all light units of each individual sub-module.

Typically, but not necessarily, the number of sub-modules S is an integer N times the number L of light units in each sub-module, i.e. S=N×L. In FIG. 5 an embodiment where the integer is two is shown. The number of sub-modules 502-507 of the LED light source 501 is six and the number of LEDs 508a-c within each sub-module is three, i.e. S=2×3=6. The sub-modules are arranged close together. Looking at any combination of three neighbouring sub-modules the LEDs 508a-c are rotated either clockwise or counter clockwise when moving clockwise from one sub-module to the next in the combination.

In another embodiment of the LED light source, as shown in FIG. 6, N=3 and L=3, and thus there are nine sub-modules 601-609. Again the LEDs are rotated.

Above, embodiments of the LED light source according to the present invention have been described. These should be seen as merely non-limiting examples. As understood by a skilled person, many modifications and alternative embodiments are possible within the scope of the invention, as defined by the appended claims.

For example, the mutual relationship between the LED groups can be other than the described LED rotations and different LED colour combinations in different sub-modules.

It should also be noted that in embodiments where the same light unit colour combination, for example RGB, is used in several sub-modules, although with some type of permutations, the emitted light of light units in different sub-modules are usually not exactly identical in colour. However, they are still defined as the same colour. Such unintended minor variations in colour will deteriorate the colour uniformity to a certain degree. On the other hand they will improve the colour rendering index (CRI) of the light source.

As an alternative embodiment a number of sub-modules not fulfilling the equation S=N×L is arranged. For example, there are four sub-modules of three light units each. The same colour combination, for example RGB, is used throughout but positional permutation is used. Then there are two sub-modules having the same orientation of the light unit colours. In this embodiment it is preferred that the two identical sub-modules are dimmed, i.e. their light output is decreased in relation to the other sub-modules, to balance their contribution to that of the other sub-modules.

It is to be noted, that for the purposes of this application, and in particular with regard to the appended claims, the word “comprising” does not exclude other units or steps, that the word “a” or “an”, does not exclude a plurality, which per se will be apparent to a person skilled in the art.

1. A composite light source for generating light of a predetermined colour, the light source comprising a plurality of sub-modules, each sub-module comprising
a light collimating and mixing structure; and
a light unit group comprising a plurality of coloured light units disposed at an entrance of the collimating and mixing structure,
wherein the sub-modules are arranged with a predetermined mutual relationship of their respective light unit groups for obtaining a homogenizing interaction of the light emitted from the light unit groups, wherein an implementation of said relationship comprises that, at a given light unit position in at least some of the light unit groups, there are provided differently coloured light units.

2. A composite light source according to claim 1, wherein said implementation of said relationship comprises a positional permutation of light units of different light unit groups.

3. A composite light source according to claim 2, wherein said positional permutations are implemented such that the light units of each colour occupy all different positions at the sub-modules throughout the composite light source at least once.

4. A composite light source according to claim 2, wherein said positional permutation is implemented as a rotation of the light unit groups of different sub-modules relative to each others.

5. A composite light source according to claim 1, wherein different light unit groups are provided with differently coloured light units.

6. A composite light source according to claim 1, wherein implementation of said relationship comprises an arrangement of said light units by means of which the light emitted from all of the light units at an optional position of the light unit groups add up to light of the same colour as the colour of the total light emitted from the composite light source.

7. A composite light source according to claim 1, wherein the number of sub-modules of the composite light source is greater than or equal to the number of coloured light units of each sub-module.

8. A composite light source according to claim 1, wherein the number of sub-modules is an integer multiple of the number of light units of each sub-module.

9. A composite light source according to claim 1, wherein the light units are LEDs.
